(19) United States
(12) Patent Application Publication
(10) Pub. No.: US 2012/0124181 A1
(43) Pub. Date: May 17, 2012

(54) COMPUTER PERIPHERAL DEVICE AND INTERACTION SYSTEM THEREOF

(75) Inventors: Peng-Yang Chen, New Taipei City (TW); Wen-Ten Lin, New Taipei City (TW)

(73) Assignees: Kinpo Electronics, Inc., New Taipei City (TW); Cal-Comp Electronics & Communications Company Limited, New Taipei City (TW)

(21) Appl. No.: 13/298,299

(22) Filed: Nov. 17, 2011

(30) Foreign Application Priority Data
Nov. 17, 2010 (TW) 99139563

(51) Int. Cl. G06F 15/16

(52) U.S. Cl. 709/219

(57) ABSTRACT

A computer peripheral device and an interaction system thereof are provided, and the provided computer peripheral device includes a server unit, a hardware unit and a firmware unit. The server unit provides a user interface on a web server, so as to allow a user to set the operation parameters of the computer peripheral device through the user interface. The firmware unit controls the hardware unit to execute a word processing action on a document to be processed according to the operation parameters set by the user.

This application claims the priority benefit of Taiwan application serial no. 99139563, filed Nov. 17, 2010. The entirety of the above-mentioned patent application is hereby incorporated by reference herein and made a part of this specification.

### BACKGROUND OF THE INVENTION

1. Field of the Invention

The present invention generally relates to a computer peripheral device, more particular, to a computer peripheral device without the need of installing a specific driver in a computer.

2. Description of Related Art

With the great progress of technology in modern society, personal computers (PCs) and peripheral devices (equipment) thereof also have higher speed and more functions. In the office nowadays, various office equipment, for example, photocopiers, fax machines and printers, is indispensable information equipment. Furthermore, the office equipment gradually evolves from equipment with a single function into multi-functional equipment, for example, a multi-function printer (MFP) integrated with faxing, photocopying, printing and scanning functions.

Conventionally, in order to use office equipment connected to a PC through the PC, a corresponding driver must be installed in the PC first, so as to enable a user to control the office equipment through the PC to execute word processing. However, such method often causes inconvenience in use. For example, when the user is connected to the office equipment through a different computer, and if the driver is not installed in the computer, the user must download the driver through a network and install the driver, or the user has to find the drive disk attached to the product when the office equipment was originally purchased so as to install the driver in the used computer, before the user controls the office equipment through the PC to execute word processing operations such as faxing, photocopying, printing and scanning.

In other words, if a driver download link provided on the website of the product fails, or the quality of the network is poor so that a lot of time is spent in downloading the driver, or the drive disk is lost, the working efficiency of the user is seriously affected, and the user is even unable to execute relevant word processing. In addition, for users unfamiliar with computer operations, the action of installing the driver is a heavy burden, and even if such users have the driver on hand which can be installed, much trouble is caused for them. Therefore, how to reduce the inconvenience caused to users by installing the driver is an important problem to be solved in the field of the present invention.

### SUMMARY OF THE INVENTION

Accordingly, the present invention is directed to a computer peripheral device, which is capable of executing word processing under the control of a computer without the need of installing a specific/corresponding driver in the computer, so as to solve the problem described in the prior art.

The present invention provides a computer peripheral device, which includes a server unit, a hardware unit and a firmware unit. The server unit is used for providing a user interface (UI) on a web server, so as to allow a user to set an operation parameter of the computer peripheral device through the UI. The firmware unit is served as a communication bridge between the server unit and the hardware unit, and controls the hardware unit to execute a word processing action on a document to be processed according to the operation parameter set by the user.

In an embodiment of the present invention, the computer peripheral device may include a fax machine, an MFP or a scanner.

In an embodiment of the present invention, the computer peripheral device may further include a common gateway interface (CGI), which is served as a communication bridge between the server unit and the firmware unit.

In an embodiment of the present invention, the user may be connected to the computer peripheral device through a web browser of a local-end computer, so as to set the operation parameter of the computer peripheral device on the UI.

In an embodiment of the present invention, the computer peripheral device may further include a storage unit, which is used for storing a file data obtained after the hardware unit executes the word processing action on the document to be processed. Moreover, the user may further be connected to the computer peripheral device through the web browser of the local-end computer to download the file data.

In an embodiment of the present invention, another user may be connected to the computer peripheral device through a web browser of a far-end computer to download the file data.

The present invention further provides an interaction system, which includes a computer peripheral device, a local-end computer and a far-end computer. The computer peripheral device is capable of providing a UI on a web server and has a word processing capability. A user may be connected to the computer peripheral device through a web browser of the local-end computer, so as to set an operation parameter of the computer peripheral device on the UI, thereby controlling the computer peripheral device to execute a word processing action on a document to be processed and store a file data obtained after the word processing action is executed on the document to be processed. Another user may be connected to the computer peripheral device through a web browser of the far-end computer to download the file data.

Based on the above, in the present invention, a web server in a computer peripheral device provides a UI which can be connected by a web browser of a computer, so as to allow a user to set all operation parameters of the computer peripheral device directly on the UI provided by the web browser so as to execute a corresponding word processing action. In this way, no driver needs to be installed in the computer, thereby greatly improving the use convenience of the computer peripheral device.

In order to make the aforementioned features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an interaction system according to an embodiment of the present invention.

FIG. 2 is a detailed schematic view of the interaction system in FIG. 1.

FIG. 3 is a schematic view of a UI according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

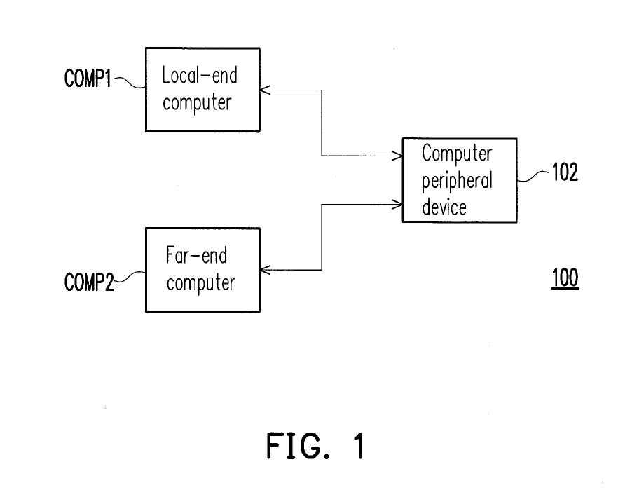

FIG. 1 is a schematic view of an interaction system according to an embodiment of the present invention. Referring to FIG. 1, the interaction system 100 includes a local-end computer COMP1, a far-end computer COMP2 and a computer peripheral device 102. The local-end computer COMP 1 and the far-end computer COMP2 may be PCs, notebook computers, personal digital assistant (PDA) phones, smart phones or other computing devices having an Internet access function in accordance with a Hypertext Transfer Protocol (HTTP) (but not limited thereto).

Moreover, the local-end computer COMP1 and the far-end computer COMP2 can be connected to the computer peripheral device 102 through a network. Accordingly, the computer peripheral device 102 can provide a UI on a web server, so as to allow a user to be connected, through a web browser (for example, Internet Explorer) of the local-end computer COMP1, to the UI provided by the computer peripheral device 102 to set operation parameters of the computer peripheral device 102, thereby controlling the computer peripheral device 102 to execute a word processing action (for example, scanning or faxing) on a document to be processed and store a file data obtained after word processing is executed on the document to be processed. In addition, another user of the far-end computer COMP2 can be connected to the computer peripheral device 102 through a web browser to download the file data stored in the computer peripheral device 102 without the need of executing the word processing action repeatedly.

As described above, the interaction system 100 disclosed in the above embodiment allows a user to set operation parameters of the computer peripheral device 102 on a UI provided by the computer peripheral device 102 on a web server, so as to control the computer peripheral device 102 to execute a word processing action on a document to be processed. In this way, the step of installing a driver in the computer is omitted and the situation that the user fails to use the computer peripheral device 102 if the user is unfamiliar with the computer installation procedure or loses the driver as described in the prior art does not exist. It should be noted that, although the computer peripheral device 102 is connected to only the local-end computer COMP 1 and the far-end computer COMP2 through the network in this embodiment, the present invention is not limited thereto, and the computer peripheral device 102 may be connected to more computer devices through the network depending on the actual application.

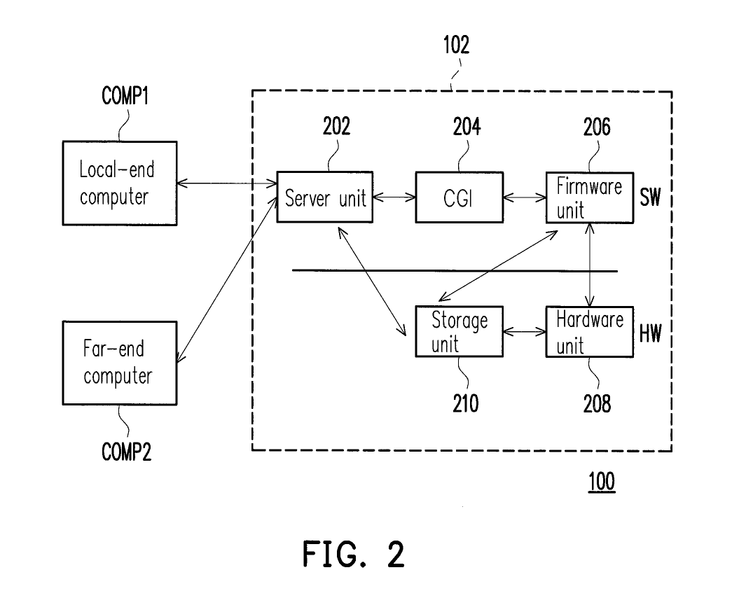

Specifically, FIG. 2 is a detailed schematic view of the interaction system in

FIG. 1. Referring to FIG. 2, the computer peripheral device 102 of the interaction system 100 in this embodiment may include a software layer SW and a hardware layer HW in general. The software layer SW includes a server unit 202, a common gateway interface (CGI) 204 and a firmware unit 206, moreover, the hardware layer HW includes a hardware unit 208 and a storage unit 210.

As regards the hardware layer HW, if the computer peripheral device 102 is a scanner, the hardware unit 208 includes all hardware parts of a general scanner; if the computer peripheral device 102 is a fax machine, the hardware unit 208 includes all hardware parts of a general fax machine; and if the computer peripheral device 102 is an MFP, the hardware unit 208 includes all hardware parts of a general MFP. In addition, the storage unit 210 may be any type of non-volatile memory, for example, a hard-disc, a flash memory, an electrically erasable programmable read only memory (EEPROM) or the like.

As regards the software layer SW, the server unit 202 can provide a UI on a web server, so as to allow a user to set operation parameters of the computer peripheral device 102, through the local-end computer COMP1, on the UI provided by the web server. The CGI 204 is served as a communication bridge between the server unit 202 and the firmware unit 206. After the user sets the operation parameters of the computer peripheral device 102 through the UI, the server unit 202 transfers the operation parameters set by the user to the firmware unit 206 through the CGI 204. The firmware unit 206 is served as a communication bridge between the server unit 202 and the hardware unit 208, and controls the hardware unit 208 to execute a word processing action (for example, faxing, photocopying, printing, scanning or other word processing operations) on a document to be processed according to the operation parameters set by the user. In this way, the storage unit 210 stores a file data obtained after the hardware unit 208 executes the word processing action on the document to be processed.

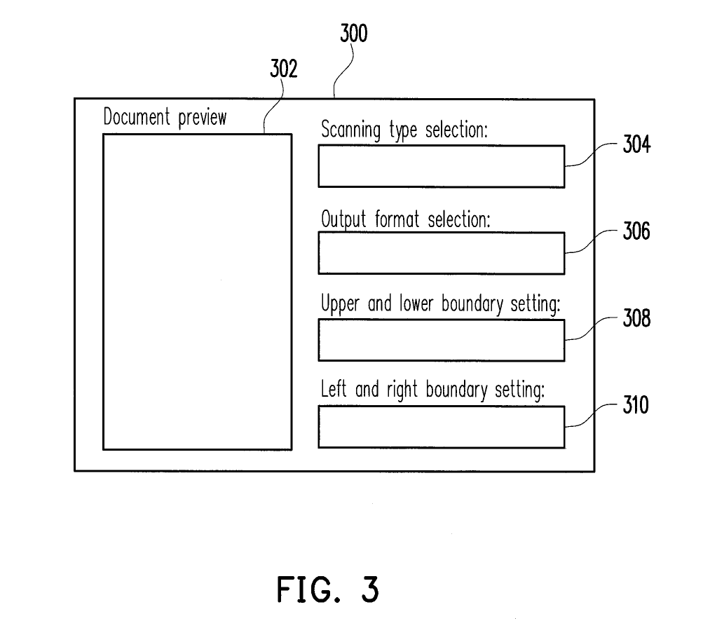

In particular, when the user intends to scan a document, first, the document to be scanned is placed on the hardware unit 208, and then the user is connected to the computer peripheral device 102 through a web browser of the local-end computer COMP 1 to set operation parameters (namely, scanning parameters) of the computer peripheral device 102 through the UI. In this embodiment, the UI provided by the web server may be as shown in FIG. 3, and the UI 300 may include, but not limited to, an output document preview window 302, a scanning type selection field 304, an output format selection field 306, an upper and lower boundary setting field 308, a left and right boundary setting field 310 and so on.

Generally speaking, the output document preview window 302 is used for previewing a scanning range of the document. The scanning type selection field 304 can adjust a scanning mode according to different types of documents, for example, may set the scanning mode as scanning for text or image. The output format selection field 306 can set an output file of the scanner to be in black and white or color. The upper and lower boundary setting field 308 and the left and right boundary setting field 310 can set the scanning range of the document. In other embodiments of the present invention, the UI 300 provided by the server unit 202 may further include a user identity authentication function for improving the security of document data.

After the user sets the operation parameters (namely, the scanning parameters) of the computer peripheral device 102, the set operation parameters can be transferred to the firmware unit 206 through the CGI 204. In this way, upon receiving the operation parameters set by the user, the firmware unit 206 controls the computer peripheral device 102 to scan the document according to the operation parameters, and meanwhile stores a file data (namely, a scanned image) obtained after scanning the document in the storage unit 210, so that the scanned image can be shared, through the network, by all computers capable of being connected to the computer peripheral device 102. For example, users of the local-end computer COMP 1 and the far-end computer COMP2 may be respectively connected to the computer peripheral device 102 to download the file data (namely, the scanned image) stored in the storage unit 210. Although document scanning is described herein, operation manners such as document faxing, document photocopying and document printing can be deduced by persons skilled in the art, and thus will not be descried again.

Based on the above, with the server function and the UI provided by the server unit 202 in the computer peripheral device 102, the user can set operation parameters of the computer peripheral device 102 directly through the web browser so as to execute a word processing action on a document to be processed without the need of installing a driver in the computer. In this way, the inconvenience caused by installing the driver can be eliminated, so as to greatly improve the use convenience of the computer peripheral device 102.

In the above embodiment, the user sets the operation parameters of the computer peripheral device 102 through the UI on the local-end computer COMP1 and uses, on the far-end computer COMP2, the data stored when the local-end computer COMP1 executes word processing on the document, but the actual use is not limited thereto. The user may also set the operation parameters of the computer peripheral device 102 through the far-end computer COMP2, and on the contrary uses the local-end computer COMP1 to download the file data in the storage unit 210. That is to say, all computers connected to the computer peripheral device 102 can, without any driver installed therein, set the operation parameters of the computer peripheral device 102 through the network so as to control the hardware unit 208 to execute word processing on the document to be processed, or download the file data stored in the storage unit 210 from the storage unit 210.

To sum up, in the present invention, a server unit in a computer peripheral device provides a UI on a web server, so as to allow a user to set all operation parameters of the computer peripheral device directly on the UI provided by the web server, so that a firmware unit controls a hardware unit to execute a corresponding word processing action on a document to be processed according to the set operation parameters and stores a file data after word processing in a storage unit for sharing with all other computers connected to the computer peripheral device. In the above process, no driver needs to be installed in the computer, and any computer having an Internet access function can be connected to the web server through the network so as to control the computer peripheral device, thereby greatly improving the use convenience of the computer peripheral device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer peripheral device, comprising:
a server unit, for providing a user interface (UI) on a web server, so as to allow a user to set an operation parameter of the computer peripheral device through the UI;
a hardware unit; and
a firmware unit, being served as a communication bridge between the server unit and the hardware unit, and configured for controlling the hardware unit to execute a word processing action on a document to be processed according to the operation parameter set by the user.

2. The computer peripheral device according to claim 1, wherein the computer peripheral device further comprises:
a common gateway interface (CGI), being served as a communication bridge between the server unit and the firmware unit.

3. The computer peripheral device according to claim 1, wherein the user is connected to the computer peripheral device through a web browser of a local-end computer, so as to set the operation parameter of the computer peripheral device on the UI.

4. The computer peripheral device according to claim 3, further comprising:
a storage unit, configured for storing a file data obtained after the hardware unit executes the word processing action on the document to be processed,
wherein the user is further connected to the computer peripheral device through the web browser of the local-end computer to download the file data.

5. The computer peripheral device according to claim 4, wherein another user is connected to the computer peripheral device through a web browser of a far-end computer to download the file data.

6. The computer peripheral device according to claim 1, wherein the computer peripheral device comprises a fax machine, a multi-function printer (MFP) or a scanner.

7. An interaction system, comprising:
a computer peripheral device, configured for providing a user interface (UI) on a web server and having a word processing capability;
a local-end computer, wherein a user is connected to the computer peripheral device through a web browser of the local-end computer, so as to set an operation parameter of the computer peripheral device on the UI, thereby controlling the computer peripheral device to execute a word processing action on a document to be processed and store a file data obtained after the word processing action is executed on the document to be processed; and
a far-end computer, wherein another user is connected to the computer peripheral device through a web browser of the far-end computer to download the file data.

8. The interaction system according to claim 7, wherein the computer peripheral device comprises:
a server unit, configured for providing the UI on the web server, so as to allow the user to set the operation parameter of the computer peripheral device through the UI;
a hardware unit; and
a firmware unit, being served as a communication bridge between the server unit and the hardware unit, and configured for controlling the hardware unit to execute the word processing action on the document to be processed according to the operation parameter set by the user.

9. The interaction system according to claim 8, wherein the computer peripheral device further comprises:
a common gateway interface (CGI), being served as a communication bridge between the server unit and the firmware unit.

10. The interaction system according to claim 8, wherein the computer peripheral device further comprises:
a storage unit, configured for storing the file data obtained after the hardware unit executes the word processing action on the document to be processed,
wherein the user is further connected to the computer peripheral device through the web browser of the local-end computer to download the file data.

11. The interaction system according to claim 7, wherein the computer peripheral device comprises a fax machine, a multi-function printer (MFP) or a scanner.
